(19) United States
(12) Patent Application Publication
(10) Pub. No.: US 2021/0180931 A1
(43) Pub. Date: Jun. 17, 2021

(54) DEVICE FOR MEASURING WEIGHT AND LENGTH OF FISH AND METHOD THEREFOR

(71) Applicant: ATOZSOFT Corporation, Seoul (KR)

(72) Inventor: Ho Jin SUH, Seoul (KR)

(73) Assignee: ATOZSOFT Corporation, Seoul (KR)

(21) Appl. No.: 17/185,524

(22) Filed: Feb. 25, 2021

Related U.S. Application Data
(63) Continuation of application No. PCT/KR2019/011666, filed on Sep. 9, 2019.

(30) Foreign Application Priority Data
Dec. 11, 2018 (KR) 10-2018-0158841

(51) Int. Cl. G01B 3/1084; G01G 19/60; G01G 19/14; G01B 11/02; A01K 97/00

(52) U.S. Cl. CPC G01B 3/1084; G01G 19/60; A01K 97/00; G01B 11/02; G01G 19/14

(57) ABSTRACT

A device for measuring a weight and a length of a fish, the device comprising: a communication unit configured to transmit information to an external terminal; a fixing unit configured to hang and fix the fish; an elastic unit connected to the fixing unit and configured to generate an elastic force in response to the weight of the fish hanging on the fixing unit; a weight measuring unit configured to measure the elastic force using a weight sensor; and a control unit configured to generate information on the weight of the fish on the basis of the measured elastic force.

### CROSS-REFERENCE TO RELATED APPLICATIONS

The present application is a continuation application of international application No. PCT/KR2019/011666 having an international filing date of Sep. 9, 2019 and designating the United States, the international application claiming a priority date of Dec. 11, 2018 based upon prior filed K.R patent application No. 10-2018-0158841, the entire contents of the aforesaid international application and the aforesaid K.R. patent application being incorporated herein by reference.

### TECHNICAL FIELD

The present disclosure relates to a device and a method for measuring a weight and a length of a fish. In more particular, the present disclosure relates to a device and a method for measuring a weight of a fish using a weight sensor and measuring a length of the fixed fish in real time.

### BACKGROUND ART

With the recent increase in fishing population, there is an increasing need for technologies for measuring weights and lengths of caught fishes and identifying types of fishes. Therefore, a device for measuring a weight of a fish has been provided. The device for measuring a weight of a fish fixes a fish and then measures a weight of the fish placed on a fish measuring device having a flat shape and using a strain gauge. In this case, the pressure, which is applied to fix the fish, is transmitted to the device for measuring a weight of a fish, which makes it difficult to accurately measure the weight of the fish.

As described above, in the case of the device for measuring a weight of a fish using the strain gauge in the related art, there is a limitation to a material and a structure to be used, which causes a problem that makes it difficult to manufacture the device which has a small size and is light in weight. In particular, when a user catches a large fish by fishing and measures a weight and a length of the fish, the structure of the measuring device cannot reflect an overall weight of the fish, which causes a deterioration in convenience of use. In addition, the device for measuring a weight of a fish in the related art cannot measure a length of a fish, and as a result, the length of the fish needs to be separately measured.

Nevertheless, there has been provided no device for measuring a weight of a fish, which is manufactured to be in light in weight and have a small size and has a structure capable of conveniently measuring a length and a weight of a fish at the same time.

### DISCLOSURE

### Technical Problem

A technical problem to be solved by the present disclosure is to provide a device and a method for measuring a weight and a length of a fish.

Specifically, a technical problem to be solved by the present disclosure is to provide a device and a method for measuring a weight of a fish, which is applied in a gravitational direction, by hanging the fish on a weight measuring device having a fixing unit for fixing a fish.

Another technical problem to be solved by the present disclosure is to provide a device and a method for measuring a length of a fish using a provided measure ruler in a state in which the fish hangs on a fixing unit.

Still another technical problem to be solved by the present disclosure is to provide a device and a method capable of using a temperature compensation function and thus accurately measuring a weight even though the amount of deformation of an elastic body in accordance with a difference in temperature is not uniform.

Yet another technical problem to be solved by the present disclosure is to provide a device and a method capable of sharing information about a measured weight and a measured length with a user terminal and/or other user terminals.

Still yet another technical problem to be solved by the present disclosure is to provide a device and a method capable of measuring a length of a stretched elastic body using an optical sensor, thereby measuring a weight of a fish which is force applied to the elastic body.

Technical problems to be solved by the present disclosure are not limited to the above-mentioned technical problems, and other technical problems, which are not mentioned above, may be clearly understood from the following descriptions by those skilled in the art to which the present disclosure pertains.

### Technical Solution

In order to solve the above-mentioned problems, a device for measuring a weight and a length of a fish, the device comprising: a communication unit configured to transmit information to an external terminal; a fixing unit configured to hang and fix the fish; an elastic unit connected to the fixing unit and configured to generate an elastic force in response to the weight of the fish hanging on the fixing unit; a weight measuring unit configured to measure the elastic force using a weight sensor; and a control unit configured to generate information on the weight of the fish on the basis of the measured elastic force.

In the exemplary embodiment, the device further comprises: a measure ruler housing configured to accommodate a measure ruler of a tape measure type; the measure ruler configured to be pulled from the measure ruler housing; and a length measuring unit comprising a length indicator attached to an end of the measure ruler.

In the exemplary embodiment, when the measure ruler is pulled along a length of the fish hanging on the fixing unit and a length of the pulled measure ruler is not changed for a preset time or more, the control unit generates information on the length of the fish on the basis of the pulled length of the measure ruler.

In the exemplary embodiment, the device further comprises: an input unit configured to receive an input of a user for triggering measurement of the length of the fish, when the input of the user is received through the input unit, the control unit: measures a distance from a position at which the fish hangs on the fixing unit to a position of the length indicator on the basis of the pulled length of the measure ruler, and generates information on the length of the fish on the basis of the measured distance.

In the exemplary embodiment, the elastic unit is connected to the fixing unit through a first connecting member provided at a first side of the elastic unit, the elastic unit is connected to a connecting part provided in one region in the device positioned opposite to the fixing unit through a second connecting member provided at a second side of the elastic unit, the first side is bent in a downward direction by a force in a gravitational direction through the first connecting member and by the weight of the fish hanging on the fixing unit, and the second side is bent in an upward direction as tension generated by the force in the gravitational direction is transmitted to the connecting part through the second connecting member, and the elastic force is generated by the bending occurring in the upward and downward directions.

In the exemplary embodiment, the elastic unit further comprises: a first elastic member configured to provide an elastic force to the bending in the downward direction generated by the force in the gravitational direction transmitted through the first connecting member; and a second elastic member configured to provide an elastic force to the bending in the upward direction generated by the tension transmitted through the second connecting member.

In the exemplary embodiment, the communication unit transmits at least one of the information generated on the weight of the fish or the information on the length of the fish to a user terminal or a measurement server.

In the exemplary embodiment, the weight measuring unit measures, through the weight sensor, a change in a length of the elastic unit occurring as a force is applied to the elastic unit by the weight of the fish hanging on the fixing unit, the control unit controls the weight sensor to measure the change in the length, and generates the information on the weight by converting a measured change in the length in comparison with the information on the length of the elastic unit stored in advance into the weight of the fish.

In the exemplary embodiment, the weight measuring unit comprises a temperature measuring unit configured to measure a temperature of the device, the control unit: generates the information on the weight of the fish on the basis of the measured change in the length, generates a compensation value for the measured change in the length of the elastic unit on the basis of the measured temperature, and generates information on the compensated weight by correcting the generated information on the weight on the basis of the generated compensation value.

In order to solve the above-mentioned technical problems, a method of measuring a weight and a length of a fish, which is performed by a device for measuring the weight and the length of the fish, the method comprising: detecting a fixation of the fish; measuring an elastic force of an elastic unit generated by the fixed fish by using a weight sensor; generating information on a weight of the fish on the basis of the measured elastic force; generating information on a length of the fish as a measure ruler is pulled in a longitudinal direction of the fixed fish; and transmitting the generated information on the weight and the generated information on the length to an external terminal.

In order to solve the above-mentioned problems, a device for measuring a weight and a length of a fish according to an exemplary embodiment of the present disclosure may include: a communication unit configured to transmit information to an external terminal; a fixing unit configured to hang and fix a fish; an elastic unit connected to the fixing unit and configured to generate elastic force in response to a weight of the fish hanging on the fixing unit; a weight measuring unit configured to measure the elastic force using a weight sensor; and a control unit configured to generate information on weight of the fish on the basis of the measured elastic force.

In the exemplary embodiment, the device may further include: a measure housing configured to receive a tape measure; the measure configured to be pulled from the measure housing; and a length measuring unit including a length indicator attached to an end of the measure.

In the exemplary embodiment, when the measure is pulled along a length of the fish hanging on the fixing unit and a length of the pulled measure is not changed for a preset time or more, the control unit may generate information on the length of the fish on the basis of the length of the pulled measure.

In the exemplary embodiment, the device may further include: an input unit configured to receive an input of a user for triggering measurement of the length of the fish, in which when the input of the user is received through the input unit, the control unit measures a distance from a position at which the fish hangs on the fixing unit to a position of the indicator on the basis of the length of the pulled measure, and the control unit may generate information on the length of the fish on the basis of the measured distance.

In the exemplary embodiment, the elastic unit may be connected to the fixing unit through a first connecting member provided at a first side of the elastic unit, the elastic unit may be connected to a connecting part provided in one region in the device positioned opposite to the fixing unit through a second connecting member provided at a second side of the elastic unit, the first side may be bent in a downward direction by a force in a gravitational direction through the first connecting member by the weight of the fish hanging on the fixing unit, and the second side may be bent in an upward direction as tension generated by the force in the gravitational direction is transmitted to the connecting part through the second connecting member, and the elastic force may be generated by the bending occurring in the upward and downward directions.

In the exemplary embodiment, the elastic unit may further include: a first elastic member configured to provide an elastic force to the bending in the downward direction generated by the force in the gravitational direction transmitted through the first connecting member; and a second elastic member configured to provide an elastic force to the bending in the upward direction generated by the tension transmitted through the second connecting member.

In the exemplary embodiment, the communication unit may transmit at least one of the information generated on the weight of the fish and the information on the length of the fish to a user terminal or a measurement server.

In the exemplary embodiment, the weight measuring unit may measure, through the weight sensor, a change in length of the elastic unit occurring as a force is applied to the elastic unit by the weight of the fish hanging on the fixing unit, the control unit may control the weight sensor to measure the change in length, and the control unit may generate the information on the weight by converting the measured change in length into the weight of the fish in comparison with the information on the length of the elastic unit stored in advance.

In the exemplary embodiment, the weight measuring unit may include a temperature measuring unit configured to measure a temperature of the device for measuring a weight and length of a fish, the control unit may generate the information on the weight of the fish on the basis of the measured change in length, the control unit may generate a compensation value for the measured change in length of the elastic unit on the basis of the measured temperature, and the control unit may generate information on the compensated weight by correcting the generated information on the weight on the basis of the generated compensation value.

In order to solve the above-mentioned technical problems, a method of measuring a weight and length of a fish according to another exemplary embodiment of the present disclosure may be performed by a device for measuring a weight and length of a fish. Specifically, the method of measuring a weight and length of a fish may include: detecting a fixed fish; measuring an elastic force of an elastic unit generated by the fixed fish by using a weight sensor; generating information on a weight of the fish on the basis of the measured elastic force; generating information on a length of the fish as a measure is pulled in a longitudinal direction of the fixed fish; and transmitting the generated information on the weight and the generated information on the length to an external terminal.

### Advantageous Effects

According to the exemplary embodiment of the present disclosure, the fish measuring device designed to have a hanger is provided, and as a result, there is an advantage in that the device for measuring a weight of a fish, which has a small size and is light in weight, is provided even though a strain gauge is used.

In addition, according to another exemplary embodiment of the present disclosure, the strain gauge or the elastic body may be made of various materials in addition to a metal material, and as a result, there is an advantage in that costs required to manufacture the measurement devices may be minimized.

In addition, according to still another exemplary embodiment of the present disclosure, the measured weight and the measured length are shared through the communication network, and as a result, there is an effect in that it is possible to compare fishes caught by users who perform fishing at different locations.

### DESCRIPTION OF DRAWINGS

FIG. 1 is a conceptual view of a fish measuring system according to an exemplary embodiment of the present disclosure.

FIG. 2 is a view illustrating an example of a fish measuring device on which a fish is hung and fixed according to several exemplary embodiments of the present disclosure.

FIG. 3 is a block diagram of a fish measuring device according to another exemplary embodiment of the present disclosure.

FIGS. 4 and 5 are exemplified views for explaining the weight measuring unit according to the several exemplary embodiments of the present disclosure.

FIG. 6 is an exemplified view for explaining a length measuring unit according to the several exemplary embodiments of the present disclosure.

FIG. 7 is an exemplified view for explaining an elastic unit according to the several exemplary embodiments of the present disclosure.

FIG. 8 is a flowchart of a fish measuring method according to yet another exemplary embodiment of the present disclosure.

### BEST MODE

Hereinafter, exemplary embodiments of the present disclosure will be described in detail with reference to the accompanying drawings. Advantages and features of the present disclosure and methods of achieving the advantages and features will be clear with reference to exemplary embodiments described in detail below together with the accompanying drawings. However, the present disclosure is not limited to the exemplary embodiments disclosed herein but will be implemented in various forms. The exemplary embodiments of the present disclosure are provided so that the present disclosure is completely disclosed, and a person with ordinary skill in the art can fully understand the scope of the present disclosure. The present disclosure will be defined only by the scope of the appended claims. Throughout the specification, the same reference numerals denote the same constituent elements.

Unless otherwise defined, all terms (including technical and scientific terms) used in the present specification may be used as the meaning which may be commonly understood by the person with ordinary skill in the art, to which the present disclosure belongs. In addition, terms defined in a generally used dictionary shall not be construed in ideal or excessively formal meanings unless they are clearly and specially defined in the present specification. The terms used in the present specification are for explaining the exemplary embodiments, not for limiting the present disclosure. Unless particularly stated otherwise in the present specification, a singular form also includes a plural form.

In the present specification, for convenience of description, a device for measuring a weight and a length of a fish is simply referred to as a fish measuring device.

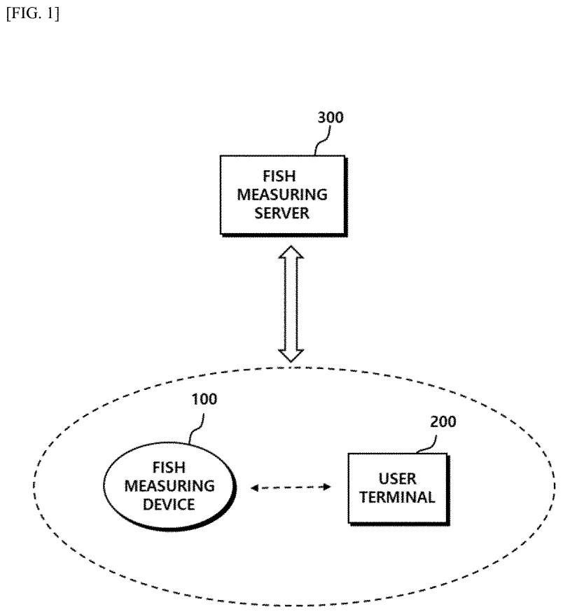

FIG. 1 is a conceptual view of a fish measuring system according to an exemplary embodiment of the present disclosure.

Referring to FIG. 1, the fish measuring system may include a fish measuring device 100, a user terminal 200, and a fish measuring server 300.

The fish measuring device 100 refers to a device capable of hanging and lifting a fish caught through a fishing activity. A user, which performs a fishing leisure activity, may take a picture of a fish or measure a weight or a length of the fish before storing the caught fish in a net or a fish storing box. In this case, a pincer type fishing grip is used to fix the fish, and the fish measuring device 100 according to the exemplary embodiment of the present disclosure may have a fixing unit that may be used as the fishing grip. The user may hold the fish measuring device 100 while hanging the fish on the fixing unit and then take a picture.

According to another exemplary embodiment of the present disclosure, the fish measuring device 100 may measure a weight of the fish by hanging the fish on the fixing unit. In addition, the fish measuring device 100 may measure a length of the fish using a tape measure embedded in a longitudinal direction of the hanging fish. That is, the fish measuring device 100 serves as a measurement device capable of measuring the weight and the length of the fish.

According to still another exemplary embodiment of the present disclosure, the fish measuring device 100 may generate information on the measured weight and/or length of the fish and share the information with the user terminal 200.

To this end, the fish measuring device 100 may have a communication unit, and the communication unit may have a communication module in order to perform wireless data communication with external terminals. That is, the fish measuring device 100 may serve as a computing device capable of generating information on the measured fish and communicating with the external terminals. In this case, the external terminals mean computing devices such as the user terminal 200, other user terminals, and the fish measuring server 300, other than the fish measuring device 100. According to the exemplary embodiment, the fish measuring device 100 may share the information on the measured fish with the user terminal 200 by means of a short-range communication method.

The user terminal 200 is a terminal of a fishing member who enjoys fishing leisure. For example, the user terminal 200 may be a terminal owned by a user of the fish measuring device 100. For example, the user terminal 200 may be any one of mobile computing devices such as a smartphone, a tablet PC, a laptop PC, or a PDA, wearable computing devices such as smart glasses or a smart clock, and image computing devices such as a virtual reality (VR) image device and an augmented reality (AR) image device.

The user terminal 200 may share the information on the weight and length of the fish caught by the fishing leisure activity with the fish measuring device 100 and transmit the information to the fish measuring server 300. The user terminal 200 may generate information on fishing conditions such as fishing locations, seasons, tide, and weather from the fish measuring device 100. In particular, the user terminal 200 may match the information on the fishing conditions with the information on the weight and/or length of the fish provided from the fish measuring device 100. In addition, the user terminal 200 may generate a single data set by combining the shared information on the weight and/or length of the fish and the generated information on the fishing conditions. The single data set may be a constituent unit of a web service screen provided by the fish measuring server 300.

For example, the user terminal 200 may acquire image information on the fish fixed by hanging on the fish measuring device 100 and analyze the acquired image, thereby identifying the type of fish. To this end, the user terminal 200 may have a machine learning model for identifying the type of fish. The user terminal 200 may transmit the generated information to the fish measuring server 300.

As another example, the information on the weight and/or length of the fish may be transmitted directly to the fish measuring server 300 from the fish measuring device 100. That is, the fish measuring device 100 may transmit the information to the fish measuring server 300 by means of wireless communication in addition to the method of sharing the information with the user terminal 200. The fish measuring server 300 may store log data generated by the fish measuring device 100.

The fish measuring server 300 may be a stationary computing device such as a desktop PC or a server device, but the exemplary embodiment of the present disclosure is not limited thereto.

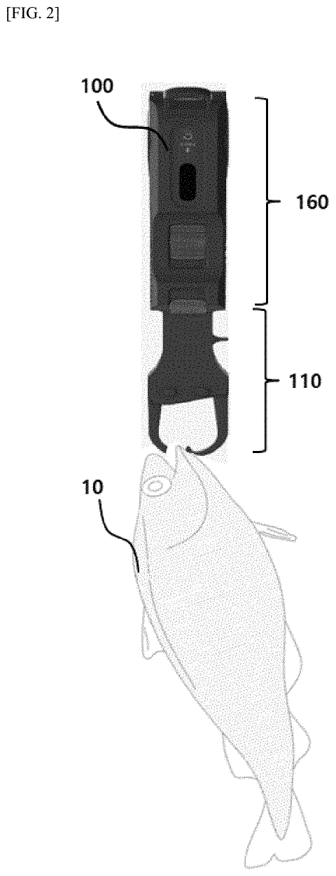

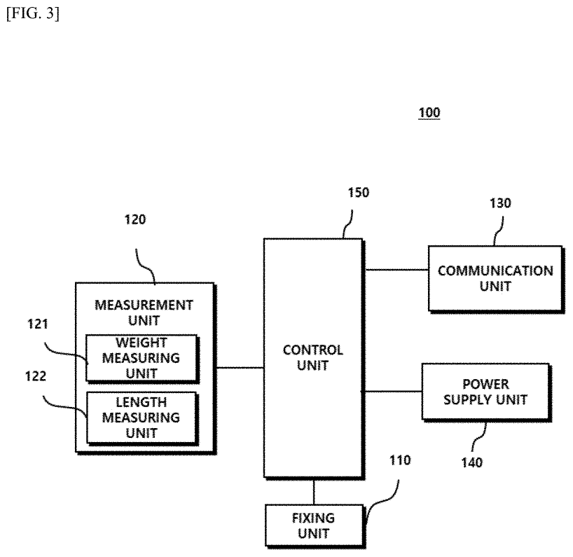

Next, the fish measuring device 100 will be more specifically described with reference to FIGS. 2 and 3. FIG. 2 is a view illustrating an example of the fish measuring device 100 on which a fish is hung and fixed according to several exemplary embodiments of the present disclosure. FIG. 3 is a block diagram of the fish measuring device 100 according to another exemplary embodiment of the present disclosure.

Referring to FIG. 2, the fish measuring device 100 may include a fixing unit 110 and a body unit 160. FIG. 2 illustrates an example in which the fixing unit 110 is provided in the form of pincers which are opened or closed by a lever. The user may manipulate the lever and pinch and fix a head, a mouth, or gills of a fish 10 with the pincers. The user may hold the body unit 160 and move or pinch the fish 10 hanging on the fixing unit 110. The body unit 160 may receive components of the fish measuring device 100 and constitute a housing of the fish measuring device 100 with the fixing unit 110.

Referring to FIG. 3, the fish measuring device 100 may include the fixing unit 110, a measurement unit 120, a communication unit 130, a power supply unit 140, and a control unit 150. Although not illustrated, the fish measuring device 100 may further include an input unit and/or an output unit that provide an interface with the user.

According to the exemplary embodiment, all or some of the measurement unit 120, the communication unit 130, the power supply unit 140, and the control unit 150 may be embedded in the body unit 160 illustrated in FIG. 2. For example, the power supply unit 140 may be provided on the fish measuring device 100 and may have a structure attachable to an outer surface of the body unit 160.

The measurement unit 120 may include a weight measuring unit 121 and a length measuring unit 122.

The weight measuring unit 121 measures a weight of the fish 10. When the fish 10 is fixed to the fixing unit 110, the fish measuring device 100 receives a force in the gravitational direction through the fixing unit 110 by the weight of the fish 10. According to the exemplary embodiment of the present disclosure, the weight measuring unit 121 may optically measure a change in length of an elastic unit changed by the weight. To this end, the weight measuring unit 121 may have a weight sensor.

For example, the fish weight measuring device 100 may adopt the weight sensor to which a measurement method using a strain gauge is applied. The strain gauge is a sensor that measures a deformation amount when the weight of the fish is applied as a force and converts the deformation amount into an electrical signal.

As another example, the fish weight measuring device 100 may adopt a weight sensor to which an optical measurement method is applied.

In addition, the weight measuring unit 121 may include the elastic unit. The elastic unit extends from the fixing unit 110 and changes in length by the force in the gravitational direction applied to the fixing unit 110.

According to the exemplary embodiment of the present disclosure, the measurement method using the strain gauge is used, and the elastic unit may be made of metal or various materials having elastic force. When the weight of the fish is applied, one side of the elastic unit receives a downward force, and the other side of the elastic unit receives a force in a direction in which a connecting part is connected, and as a result, the elastic unit is bent. The weight sensor measures the physical bending and converts the physical bending into an electrical signal, thereby measuring the weight of the fish.

According to another exemplary embodiment of the present disclosure, an optical measurement method is used, and the elastic unit may be made of various materials other than metal. For example, the elastic unit may be made of a plastic material.

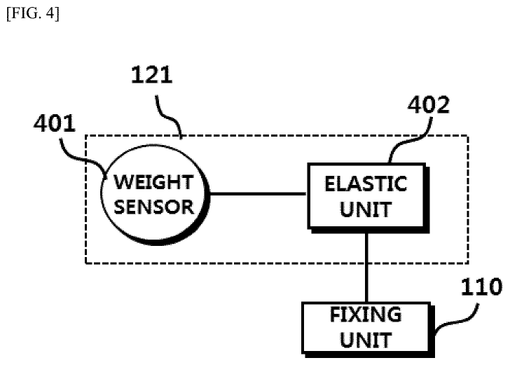

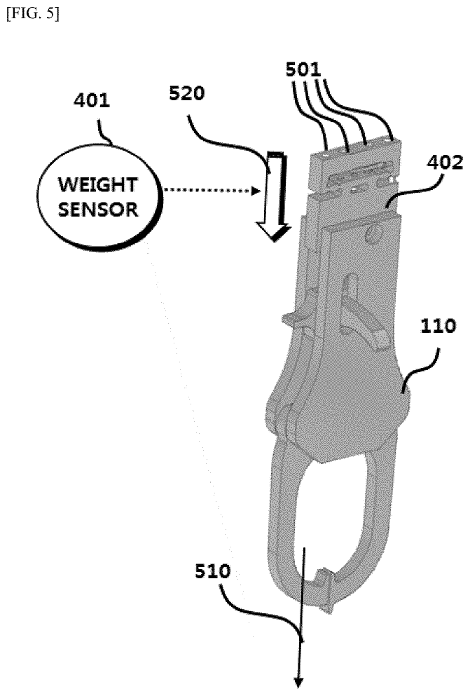

An operation of the weight measuring unit 121 will be described below with reference to FIGS. 4 and 5.

The length measuring unit 122 measures the length of the fish 10. When the fish 10 is fixed to the fixing unit 110, the tape measure is pulled in the longitudinal direction of the fish 10 by a body length of the fish, thereby measuring the length of the fish. To this end, the tape measure is wound in the length measuring unit 122, and when the user holds an indicator positioned at an end of the tape measure and pulls the tape measure, such that the tape measure is extended to the outside of the length measuring unit 122. The tape measure may be wound and stored in a measure ruler housing.

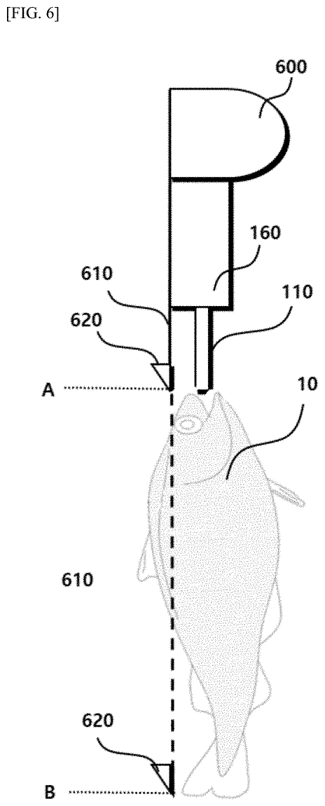

The length measuring unit 122 may be embedded in the body unit 160, but the exemplary embodiment of the present disclosure is not limited thereto. The measure ruler housing may be formed integrally with the body unit 160. That is, the measure ruler housing may constitute a part of the body unit 160, such that a part of the body unit 160 may be serve as the measure ruler housing, and the remaining region of the body unit 160 may serve as a housing that stores other components of the fish measuring device 100. An operation of the length measuring unit 122 will be described below with reference to FIG. 6.

The communication unit 130 supports wired or wireless Internet communication of the fish measuring device 100. In addition, the communication unit 130 may support various communication methods other than the Internet which is a public communication network. The communication unit 130 may include one or more modules that enable direct communication between the fish measuring device 100 and a wireless communication system, between the fish measuring device 100 and another fish measuring device, or between the fish measuring device 100 and the user terminal 200 or enables wireless communication between the fish measuring device 100 and a network in which the external terminal (the user terminal or the fish measuring server) is positioned.

The communication unit 130 may include at least one of a broadcast reception module, a mobile communication module, a wireless Internet module, a short-range communication module, and a position information module. According to the exemplary embodiment of the present disclosure, the communication unit 130 may include a BLE (Bluetooth Low Energy) module for supporting low-power short-range wireless communication between the fish measuring device 100 and the user terminal 200.

According to the exemplary embodiment of the present disclosure, the communication unit 130 may transmit, to the external terminal or other fish measuring devices, the information on the weight and length of the fish 10, which is generated by the fish measuring device 100, and/or information on a position of the fish measuring device 100.

The power supply unit 140 receives external power or internal power under control of the control unit 150 and supplies the power to the components included in the fish measuring device 100. The power supply unit 140 includes a battery, and the battery may be a built-in battery or a replaceable battery.

In addition, the power supply unit 140 may have a connection port, and the connection port may be configured as an example of an interface to which an external charger for supplying power is electrically connected in order to charge the battery.

As another example, the power supply unit 140 may be configured to charge the battery in a wireless manner without using the connection port. In this case, the power supply unit 140 may receive power from an external wireless power transmission device by using at least one of an inductive coupling method implemented on the basis of magnetic induction and a magnetic resonance coupling method implemented on the basis of electromagnetic resonance.

The control unit 150 controls overall operations of the respective components of the fish measuring device 100. The control unit 150 may include at least one of a central processing unit (CPU), a micro-processor unit (MPU), a micro-controller unit (MCU), an application processor (AP), and any type of processor well known in the technical field of the present disclosure. The control unit 150 may include a PCB having one or more processors.

According to the exemplary embodiment of the present disclosure, the control unit 150 may detect that the fish 10 is fixed by hanging on the fixing unit 110. In addition, the control unit 150 may detect a change in length of the elastic unit 130 and detect that the measure ruler is fixed to an end of the fish.

Although not illustrated, the fish measuring device 100 may also include a storage unit. The storage unit stores various types of data, commands, and/or information.

According to the exemplary embodiment of the present disclosure, the storage unit may store information on the weight and length of the fish 10. In addition, the storage unit may store the information on the position of the fish measuring device 100 which is acquired by the position information module provided in the communication unit 130.

The storage unit may include a volatile memory such as a RAM and a non-volatile memory such as a storage. The volatile memory may load one or more programs from the storage in order to execute the methods according to the exemplary embodiment of the present disclosure.

In addition, for example, the storage unit may include a non-volatile memory such as a read only memory (ROM), an erasable programmable ROM (EPROM), an electrically erasable programmable ROM (EEPROM), and a flash memory, a hard disc, a removable disc, or any type of computer-readable recording medium well known in the technical field to which the present disclosure pertains.

FIGS. 4 and 5 are exemplified views for explaining the weight measuring unit 121 according to the several exemplary embodiments of the present disclosure. Referring to FIG. 4, the weight measuring unit 121 may include a weight sensor 401 and an elastic unit 402. The elastic unit 402 is physically connected to the fixing unit 110.

According to the exemplary embodiment, the weight sensor 401 is a weight sensor using a strain gauge and may measure a degree of twisting or bending of the elastic unit 402.

In another exemplary embodiment, the weight sensor 401 is an optical sensor and may include a light emitting unit and a light receiving unit. In a process in which the light receiving unit detects light emitted from the light emitting unit, a change in length of the elastic unit 402 may be measured.

The exemplary embodiment of the present disclosure is not limited thereto, and various types of weight sensors 401 may be applied to the fish measuring device 100.

Before fixing the fish 10 to the fixing unit 110, the weight measuring unit 121 may measure a length of the elastic unit 402 in a default state. The control unit 150 or the storage unit may store information on the length of the elastic unit 402 in the default state.

Referring to FIG. 5, when the fish 10 is hung on the fixing unit 110, the weight of the fish 10 in the gravitational direction is applied, as a force 510, to the fixing unit 110. In this case, the force 510 is applied to the elastic unit 402 connected to the fixing unit 110, such that an elastic force of the elastic unit 402 is generated. In this case, the elastic force is generated as the elastic unit 402 is bent or changes in length.

Specifically, the elastic unit 402 changes in length 520 due to the weight of the fish 10 in comparison with the length of the elastic unit 402 in the default state before a specific object, that is, the fish 10 applies the force to the fixing unit 110. In the case in which the weight sensor 401 is an optical sensor, the change in length 520 may be measured, the change in length 520 may be converted into an electrical signal, and the electrical signal may be transmitted to the control unit 150.

Alternatively, the change in length 520 may be a difference in height between left and right portions of the elastic unit 402 that occurs when the left and right portions of the elastic unit 402 are bent in different directions. In this case, the weight sensor 401 is a sensor using a strain gauge and may measure a degree to which the elastic unit 402 is bent or twisted, and the weight sensor 401 may convert the degree into an electrical signal and transmit the electrical signal to the control unit 150.

Meanwhile, FIG. 5 illustrates a connecting part 501 of the elastic unit 402 which is connected to the body unit 160 illustrated in FIG. 2. The elastic unit 402 is physically connected to the body unit 160 through a partial connection structure of the connecting part 501. For example, the fixing unit 110 may be fixed to one internal region of the body unit 160 through the connecting part 501 that connects the fixing unit 110 and the body unit 160.

In addition, the partial structure of the connecting part 501 may provide electrical connection that transmits an electrical signal related to the change in length 520 of the elastic unit 402, which is measured by the weight sensor 401, to the control unit 150.

The connecting part 501 may be connected to one region in the body unit 160. That is, the connecting part 501 serves to connect the fixing unit 110 to the body unit 160 and may transmit the force, which is generated by the weight of the fish hanging on the fixing unit 110, to the body unit 160.

The control unit 150 may receive the information on the change in length 520 and convert the information into the weight of the fish 10.

According to another exemplary embodiment of the present disclosure, the control unit 150 may provide a temperature compensation function. To this end, the weight measuring unit 121 may include a temperature measuring unit that measures a temperature of the fish measuring device 100. The temperature of the fish measuring device 100 may mean at least one of the temperatures inside and outside the fish measuring device 100.

The control unit 150 may generate a compensation value for the change in length of the elastic unit 402 on the basis of the measured temperature. Specifically, when power is supplied to the fish measuring device 100, the control unit 150 may measure a default length of the elastic unit 402 at a first point in time and measure a first temperature at this time. Thereafter, the fish 10 is hung on the fixing unit 110 at a second point in time, and when the elastic unit 402 changes in length, the control unit 150 may measure a second temperature at the second point in time by using the temperature measuring unit. The control unit 150 may measure the changed length at the second temperature in comparison with the default length of the elastic unit 402 at the first temperature.

In this case, the control unit 150 may generate the compensation value for converting the amount of change in length of the elastic unit 402 at the second temperature into the amount of change in length at the first temperature. Alternatively, the control unit 150 may generate the compensation value for converting the default length based on the first temperature into the length of the elastic unit 402 based on the second temperature.

On the basis of the generated compensation value, the control unit 150 may correct the information on the weight which is generated by the control unit 150 without reflecting a change in temperature. That is, the control unit 150 may generate the information on weight to which the compensation value has been applied.

FIG. 6 is an exemplified view for explaining the length measuring unit according to the several exemplary embodiments of the present disclosure. FIG. 6 illustrates an example in which the length measuring unit 122 is a measure ruler housing 600 configured separately from the body unit 160.

Referring to FIG. 6, the length measuring unit 122 may include the measure ruler housing 600, a measure ruler 610 wound and accommodated in the measure ruler housing 600, and an indicator 620 attached to an end of the measure ruler 610.

In order to measure the length of the fish 10, the measure ruler 610 may be pulled, by the user, along the length of the fish 10 hanging on the fixing unit 110. Therefore, when the measure ruler 610 is pulled by the body length of the fish 10, the control unit 150 may identify that the pulling is stopped for a preset time or more. For example, when the length of the pulled measure is not changed for three seconds or more, the control unit 150 determines that the measure ruler 610 is pulled by the body length of the fish 10, and the control unit 150 may measure the length of the pulled measure ruler 610. The control unit 150 may generate the information on the length of the fish on the basis of the measured length.

According to another exemplary embodiment, the fish measuring device 100 may include an input unit for receiving an input for triggering the generation of the information on the length of the fish by the control unit 150. When the user inputs an input for generating the information on the length of the fish through the input unit, the control unit 150 determines that the measure ruler 610 is pulled by the body length of the fish 10, and the control unit 150 may generate the information on the length of the pulled measure ruler 610. As the user's input is received, the control unit 150 may measure a distance from a position at which the fish 10 hangs on the fixing unit 110 to a position of the indicator 620 on the basis of the length of the pulled measure ruler 610. The control unit 150 may generate the information on the length of the fish on the basis of the measured distance.

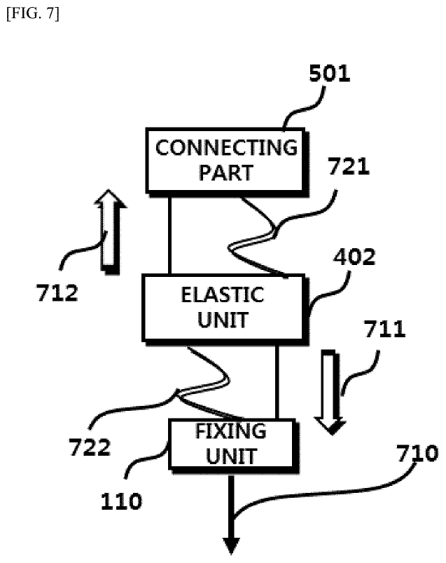

FIG. 7 is an exemplified view for explaining the elastic unit according to the several exemplary embodiments of the present disclosure. The elastic unit 402 may have a structure configured in a horizontal or vertical direction, and FIG. 7 illustrates an example in which the elastic unit 402 has a structure configured in the horizontal direction.

Referring to FIG. 7, a first right side of the elastic unit 402 may be connected to the fixing unit 110 by a connecting member. In this case, the first side receives a force 710 in the gravitational direction, which is generated by the weight of the fish hanging on the fixing unit 110, as a first force 711 through the connecting member. The first right side of the elastic unit 402 receives the first downward force 711. Therefore, the right side of the elastic unit 402 is bent in a downward direction.

In addition, a second left side of the elastic unit 402 may be connected to the connecting part 501 by a connecting member. In this case, tension, which is generated by the force 710 in the gravitational direction, generates a second force 712, such that the left side of the elastic unit 402 is bent in an upward direction.

As described above, the right side of the elastic unit 402 is bent in the downward direction, and the left side of the elastic unit 402 is bent in the upward direction, such that the elastic unit 402 generates the elastic force, and the weight sensor 401 may measure the elastic force. The elastic force may be generated not only by the bending but also by the twisting.

In another exemplary embodiment, the elastic unit 402 may have a first elastic member 721 and a second elastic member 722 in order to maintain a constant elastic force and prevent a change in structure caused by the bending in the upward and downward directions. If the bending in the upward direction or the bending in the downward direction is repeated, the elastic unit 402 sometimes cannot be restored to an original shape, and this situation occurs more frequently when the elastic unit 402 is made of metal. In addition, a problem such as damage may occur when the elastic unit 402 is made of a plastic material. In order to prevent this problem, the first elastic member 721 and the second elastic member 722 are provided to generate an elastic force in response to the first force 711 and the second force 712. In this case, the control unit 150 may finally measure the weight of the fish by adding the compensation value to the elastic force measured by the weight sensor 401 so that the weight sensor 401 reflects a reduction in elastic force caused by the first elastic member 721 and the second elastic member 722.

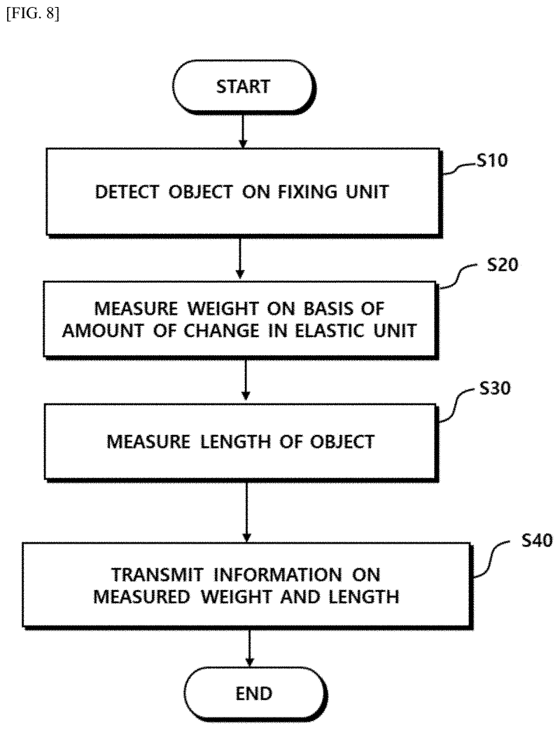

FIG. 8 is a flowchart of a fish measuring method according to yet another exemplary embodiment of the present disclosure. The following steps are performed by the fish measuring device 100, and particularly, the following steps are performed as the control unit 150 controls the operations of the components of the fish measuring device 100. Referring to FIG. 8, the fish measuring device 100 may detect an object hanging on the fixing unit 110 (S10). For example, the object may be a marine product, and particularly, an example in which the object is the fish 10 will be described.

The fish measuring device 100 uses the weight measuring unit 121 and detects a change in length of the elastic unit 402 which occurs due to the weight of the object hanging on the fixing unit 110, and the fish measuring device 100 may measure the weight of the fish 10 on the basis of the change in length of the elastic unit 402 (S20).

Next, the fish measuring device 100 may measure the length of the fish 10 by using the length measuring unit 122 (S30). The fish measuring device 100 may transmit the information on the measured weight and length of the fish 10 to the external terminal (S40).

The external terminal may record the received information on the weight and length of the fish 10 and process the received information, thereby generating information related to fishing leisure.

The methods according to the exemplary embodiment of the present disclosure described above with reference to the accompanying drawings may be performed by executing a computer program implemented with computer-readable codes. The computer program may be transmitted from a first computing device to a second computing device through a network such as the Internet and installed in the second computing device, such that the computer program may be used in the second computing device. The first computing device and the second computing device include all of stationary computing devices such as server devices and desktop PCs, and mobile computing devices such as notebook computers, smartphones, and tablet PCs.

While the exemplary embodiments of the present disclosure have been described with reference to the accompanying drawings, those skilled in the art will understand that the present disclosure may be carried out in any other specific form without changing the technical spirit or an essential feature thereof. Therefore, it should be understood that the above-described exemplary embodiments are illustrative in all aspects and do not limit the present disclosure.

1. A device for measuring a weight and a length of a fish, the device comprising:
a communication unit configured to transmit information to an external terminal;
a fixing unit configured to hang and fix the fish;
an elastic unit connected to the fixing unit and configured to generate an elastic force in response to the weight of the fish hanging on the fixing unit;
a weight measuring unit configured to measure the elastic force using a weight sensor; and
a control unit configured to generate information on the weight of the fish on the basis of the measured elastic force.

2. The device of claim 1, further comprising:
a measure ruler housing configured to accommodate a measure ruler of a tape measure type;
the measure ruler configured to be pulled from the measure ruler housing; and
a length measuring unit comprising a length indicator attached to an end of the measure ruler.

3. The device of claim 2, wherein, when the measure ruler is pulled along a length of the fish hanging on the fixing unit and a length of the pulled measure ruler is not changed for a preset time or more, the control unit generates information on the length of the fish on the basis of the pulled length of the measure ruler.

4. The device of claim 2, further comprising:
an input unit configured to receive an input of a user for triggering measurement of the length of the fish,
wherein, when the input of the user is received through the input unit, the control unit:
measures a distance from a position at which the fish hangs on the fixing unit to a position of the length indicator on the basis of the pulled length of the measure ruler, and
generates information on the length of the fish on the basis of the measured distance.

5. The device of claim 1, wherein the elastic unit is connected to the fixing unit through a first connecting member provided at a first side of the elastic unit,
wherein the elastic unit is connected to a connecting part provided in one region in the device positioned opposite to the fixing unit through a second connecting member provided at a second side of the elastic unit,
wherein the first side is bent in a downward direction by a force in a gravitational direction through the first connecting member and by the weight of the fish hanging on the fixing unit, and the second side is bent in an upward direction as tension generated by the force in the gravitational direction is transmitted to the connecting part through the second connecting member, and
wherein the elastic force is generated by the bending occurring in the upward and downward directions.

6. The device of claim 5, wherein the elastic unit further comprises:
a first elastic member configured to provide an elastic force to the bending in the downward direction generated by the force in the gravitational direction transmitted through the first connecting member; and
a second elastic member configured to provide an elastic force to the bending in the upward direction generated by the tension transmitted through the second connecting member.

7. The device of claim 1, wherein the communication unit transmits at least one of the information generated on the weight of the fish or the information on the length of the fish to a user terminal or a measurement server.

8. The device of claim 1,
wherein the weight measuring unit measures, through the weight sensor, a change in a length of the elastic unit occurring as a force is applied to the elastic unit by the weight of the fish hanging on the fixing unit,
wherein the control unit controls the weight sensor to measure the change in the length, and generates the information on the weight by converting a measured change in the length in comparison with the information on the length of the elastic unit stored in advance into the weight of the fish.

9. The device of claim 8,
wherein the weight measuring unit comprises a temperature measuring unit configured to measure a temperature of the device,
wherein the control unit:
generates the information on the weight of the fish on the basis of the measured change in the length,
generates a compensation value for the measured change in the length of the elastic unit on the basis of the measured temperature, and
generates information on the compensated weight by correcting the generated information on the weight on the basis of the generated compensation value.

10. A method of measuring a weight and a length of a fish, which is performed by a device for measuring the weight and the length of the fish, the method comprising:
detecting a fixation of the fish;
measuring an elastic force of an elastic unit generated by the fixed fish by using a weight sensor;
generating information on a weight of the fish on the basis of the measured elastic force;
generating information on a length of the fish as a measure ruler is pulled in a longitudinal direction of the fixed fish; and
transmitting the generated information on the weight and the generated information on the length to an external terminal.
